(19) United States
(12) Patent Application Publication
(10) Pub. No.: US 2023/0233003 A1
(43) Pub. Date: Jul. 27, 2023

(54) Audio Emitting Pillow Assembly

(71) Applicant: Sharbell Karout, Auburn, WA (US)

(72) Inventor: Sharbell Karout, Auburn, WA (US)

(21) Appl. No.: 17/584,544

(22) Filed: Jan. 26, 2022

(51) Int. Cl. A47G 9/10; H04R 5/02

(52) U.S. Cl. CPC A47G 9/1027; H04R 5/023; A47G 9/1045; A47G 9/1081; A47G 2009/003

(57) ABSTRACT

An audio emitting pillow assembly includes a pillow that can be positioned around a user's neck. The pillow has a pair of prominences extending upwardly from the pillow and each of the prominences is positioned adjacent to a respective one of the user's ears when the pillow is positioned around the user's neck. A communication unit is integrated into the pillow and the communication unit receives streaming audio from the personal electronic device. A pair of speakers is each integrated into a respective one of the prominences and each of the speakers is aligned with a respective one of the user's ears when the pillow is positioned around the user' neck. Each of the speakers is in communication with the communication unit to audibly emit the streaming audio from the personal electronic device thereby facilitating the user to enjoy the streaming audio.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pillow devices and more particularly pertains to a new pillow device for facilitating a user to stream audio while enjoying the comfort of a pillow. The device includes a neck pillow and a pair of prominences each extending upwardly from the neck pillow. The device includes a communication unit which receives streaming audio from a personal electronic device and a pair of speakers, each positioned in a respective prominence, for emitting the streaming audio.

### (2) Description of Related Art Including Information Disclosed Under 37 CFR 1.97 and 1.98

The prior art relates to pillow devices including a neck pillow with a charger integrated into the neck pillow for charging devices. The prior art discloses a curved pillow with speakers integrated into the curved pillow and a vibration unit integrated into the curve pillow for enhancing sleep. The prior art discloses a neck pillow which has a pair of earbuds integrated into the neck pillow for listening to streaming audio.

### BRIEF SUMMARY OF THE INVENTION

An embodiment of the disclosure meets the needs presented above by generally comprising a pillow that can be positioned around a user's neck. The pillow has a pair of prominences extending upwardly from the pillow and each of the prominences is positioned adjacent to a respective one of the user's ears when the pillow is positioned around the user's neck. A communication unit is integrated into the pillow and the communication unit receives streaming audio from the personal electronic device. A pair of speakers is each integrated into a respective one of the prominences and each of the speakers is aligned with a respective one of the user's ears when the pillow is positioned around the user' neck. Each of the speakers is in communication with the communication unit to audibly emit the streaming audio from the personal electronic device thereby facilitating the user to enjoy the streaming audio.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a pillow of an embodiment of the disclosure.

FIG. 2 is a perspective phantom view of an audio emitting pillow assembly according to an embodiment of the disclosure.

FIG. 3 is a front phantom view of a pillow of an embodiment of the disclosure.

FIG. 4 is a bottom phantom view of an embodiment of the disclosure.

FIG. 5 is a front phantom view of an embodiment of the disclosure.

FIG. 6 is a perspective in-use view of an embodiment of the disclosure.

### DETAILED DESCRIPTION OF THE INVENTION

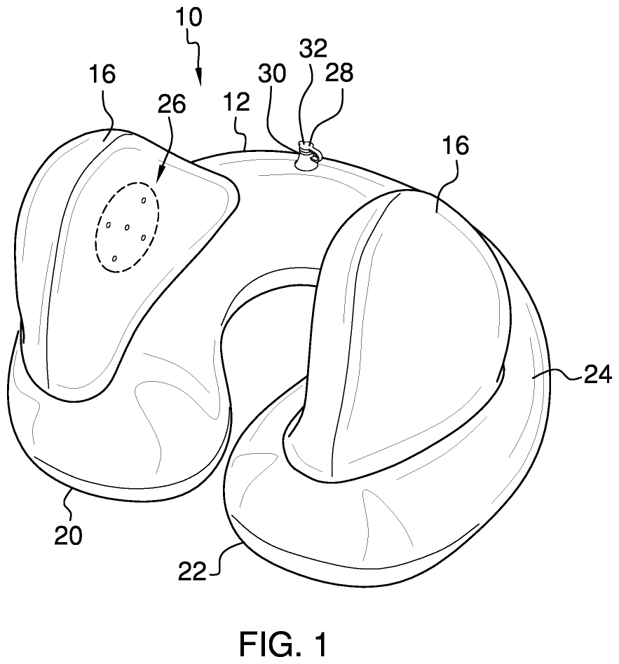

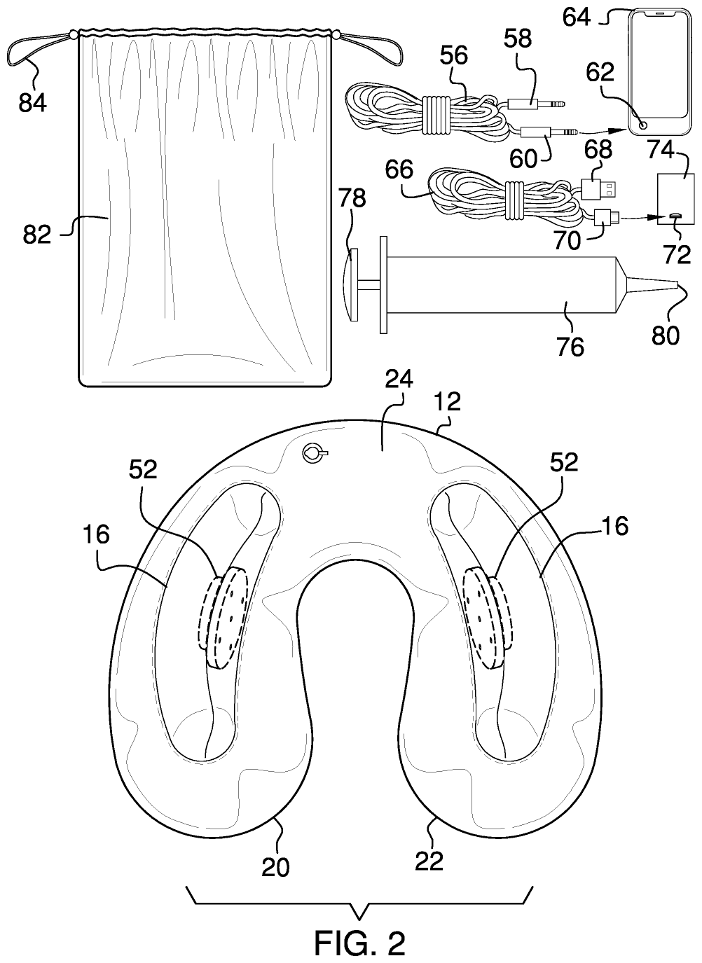

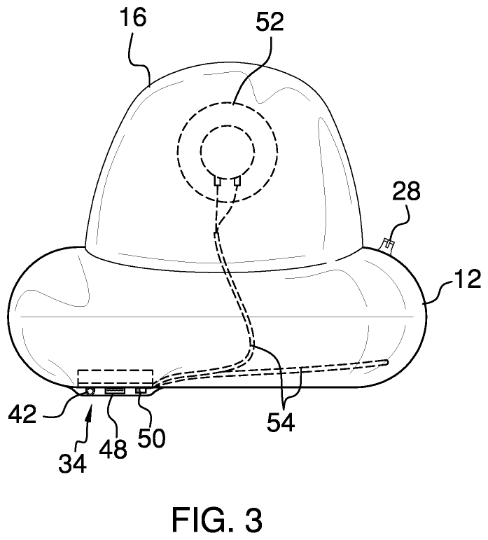

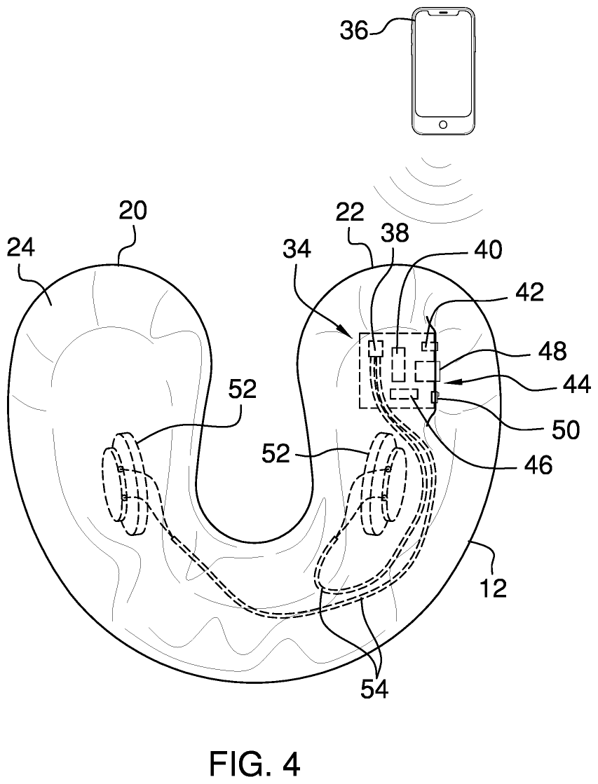

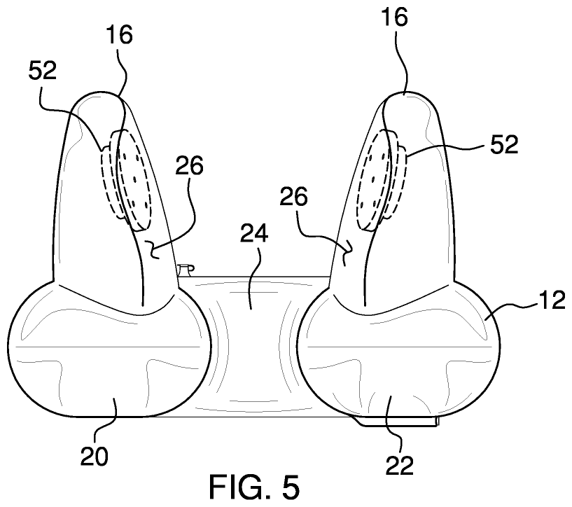

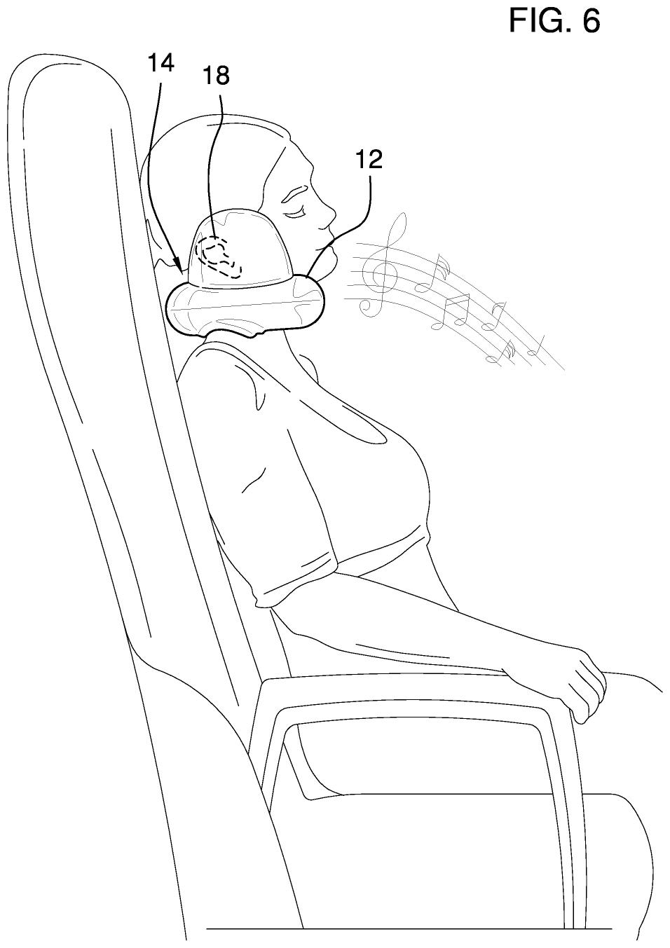

With reference now to the drawings, and in particular to FIGS. 1 through 6 thereof, a new pillow device embodying the principles and concepts of an embodiment of the disclosure and generally designated by the reference numeral 10 will be described.

As best illustrated in FIGS. 1 through 6, the audio emitting pillow assembly 10 generally comprises a pillow 12 that is substantially hollow such that the pillow 12 can be inflated. The pillow 12 is curved thereby facilitating the pillow 12 to be positioned around a user's neck 14. Furthermore, the pillow 12 has a pair of prominences 16 extending upwardly from the pillow 12. Each of the prominences 16 is positioned adjacent to a respective one of the user's ears 18 when the pillow 12 is positioned around the user's neck 14.

The pillow 12 has a first end 20, a second end 22 and an outer wall 24 extending between the first end 20 and the second end 22, and each of the first end 20 and the second end 22 tapers to a blunt point. The outer wall 24 is continuously arcuate about an axis extending between the first end 20 and the second end 22 such that the pillow 12 has a cylindrical shape. Additionally, the outer wall 24 is curved between the first end 20 and the second end 22 such that the first end 20 is spaced from the second end 22, giving the pillow 12 a U-shape. Each of the prominences 16 extends upwardly from the outer wall 24 and each of the prominences 16 is spaced an equal distance from a respective one of the first end 20 and the second end 22 of the pillow 12. Furthermore, each of the prominences 16 has a first surface 26 and the first surface 26 of each of said prominences 16 is directed toward each other. An air valve 28 is fluidly integrated into the outer wall 24 of the pillow 12 to pass air through the outer wall 24 for inflating or deflating the pillow 12. The air valve 28 has an inlet 30 and a plug 32 for closing the inlet 30.

A communication unit 34 is integrated into the pillow 12 and the communication unit 34 is in remote communication with a personal electronic device 36. In this way the communication unit 34 can receive streaming audio from the personal electronic device 36. The communication unit 34 comprises a control circuit 38 that is integrated into the pillow 12 and a receiver 40 that is integrated into the pillow 12. The receiver 40 is electrically coupled to the control circuit 38 and the receiver 40 is in wireless communication with the personal electronic device 36. Moreover, the receiver 40 receives an audio signal from the personal electronic device 36. The receiver 40 may comprise a radio frequency receiver or the like and the receiver 40 may employ Bluetooth communication protocols. Additionally, the personal electronic device 36 may comprise a smart phone or other similar device 36 that has data storage and wireless communication.

The communication unit 34 includes an input port 42 that is integrated into the outer wall 24 of the pillow 12, and the input port 42 is electrically coupled to the control circuit 38. The communication unit 34 includes a power supply 44 which is integrated into the pillow 12 and the power supply 44 is electrically coupled to the control circuit 38. The power supply 44 comprises a rechargeable battery 46 that is integrated into the pillow 12, and the rechargeable battery 46 is electrically coupled to the control circuit 38. The power supply 44 includes a charge port 48 that is integrated into the outer wall 24 of the pillow 12 and the charge port 48 is electrically coupled to the rechargeable battery 46. The power supply 44 includes a power switch 50 that is movably integrated into the outer wall 24 of the pillow 12 and the power switch 50 is electrically coupled to the control circuit 38 for turning the control circuit 38 on and off.

A pair of speakers 52 is provided and each of the speakers 52 is integrated into a respective one of the prominences 16. In this way each of the speakers 52 is aligned with a respective one of the user's ears 18 when the pillow 12 is positioned around the user's neck 14. Each of the speakers 52 is in communication with the communication unit 34 thereby facilitating each of the speakers 52 to audibly emit the streaming audio from the personal electronic device 36 thereby facilitating the user to enjoy the streaming audio. In this way the user can listen to the streaming audio without having to wear headphones or earbuds.

Each of the speakers 52 is positioned within the respective prominence 16. Additionally, each of the speakers 52 is directed toward the first surface 26 of the respective prominence 16 such that the pair of speakers 52 is directed toward each other. Each of the speakers 52 is electrically coupled to the control circuit 38. A plurality of conductors 54 is each positioned within the pillow 12 and each of the conductors 54 is electrically coupled between the control circuit 38 and a respective one of the speakers 52.

An audio cord 56 is provided that has a first plug 58 and a second plug 60, and the first plug 58 is insertable into the input port 42. The second plug 60 is insertable into an output port 62 of an audio source 64 to communicate the audio signal to the control circuit 38. A charge cord 66 is provided that has a primary plug 68 and a secondary plug 70. The primary plug 68 is insertable into the charge port 48 and the secondary plug 70 is insertable into an output port 72 of a charger 74 for charging the rechargeable battery 46.

An air pump 76 is included which has a piston 78 and an outlet 80, and the outlet 80 of the air pump 76 is insertable into the inlet 30 of the air valve 28 in the outer wall 24 of the pillow 12. The piston 78 is movable back and forth for pumping air into the pillow 12 thereby inflating the pillow 12. A storage bag 82 is provided and each of the pillow 12, the audio cord 56, the charge cord 66 and the air pump 76 is stored within the storage bag 82. Additionally, the storage bag 82 includes a drawstring 84 for closing the storage bag 82.

In use, the air pump 76 is employed to inflate the pillow 12 and the pillow 12 is worn around the user's neck 14 when the user is traveling in a vehicle, for example, or other occasion when the user will be sitting upright for an extended period of time. The power switch 50 is turned on and the receiver 40 is synched with the personal electronic device 36. In this way the speakers 52 can emit streaming audio received from the personal electronic device 36. Thus, the user can enjoy the streaming audio without the need to wear headphones or earbuds while also enjoying the comfort of the pillow 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An audio emitting pillow assembly for facilitating a user to listen to music while having their head supported in an upright position, said assembly comprising:
a pillow being substantially hollow such that said pillow can be inflated, said pillow being curved wherein said pillow is configured to be positioned around a user's neck, said pillow having a pair of prominences extending upwardly from said pillow wherein each of said prominences is configured to be positioned adjacent to a respective one of the user's ears when said pillow is positioned around the user's neck;
a communication unit being integrated into said pillow, said communication unit being in remote communication with a personal electronic device wherein said communication unit is configured to receive streaming audio from the personal electronic device;
a pair of speakers, each of said speakers being integrated into a respective one of said prominences wherein each of said speakers is configured to be aligned with a respective one of the user's ears when said pillow is positioned around the user' neck, each of said speakers being in communication with said communication unit wherein each of said speakers is configured to audibly emit the streaming audio from the personal electronic device thereby facilitating the user to enjoy the streaming audio.

2. The assembly according to claim 1, wherein:
said pillow has a first end, a second end and an outer wall extending between said first end and said second end, each of said first end and said second end tapering to a blunt point, said outer wall being continuously arcuate about an axis extending between said first end and said second end such that said pillow has a cylindrical shape, said outer wall being curved between said first end and said second end having said first end being spaced from said second end such that said pillow has a U-shape; and
each of said prominences extends upwardly from said outer wall, each of said prominences being spaced an equal distance from a respective one of said first end and said second end of said pillow, each of said prominences having a first surface being directed toward each other.

3. The assembly according to claim 2, further comprising:
an air valve being fluidly integrated into said outer wall of said pillow wherein said air valve is configured to pass air through said outer wall for inflating or deflating said pillow, said air valve having an inlet and a plug for closing said inlet; and
an air pump having a piston and an outlet, said outlet of said air pump being insertable into said inlet of said air valve in said outer wall of said pillow, said piston being movable back and forth for pumping air into said pillow thereby inflating said pillow.

4. The assembly according to claim 1, wherein said communication unit comprises:
a control circuit being integrated into said pillow;
a receiver being integrated into said pillow, said receiver being electrically coupled to said control circuit, said receiver being in wireless communication with the personal electronic device, said receiver receiving an audio signal from the personal electronic device;
an input port being integrated into said outer wall of said pillow, said input port being electrically coupled to said control circuit; and
a power supply being integrated into said pillow, said power supply being electrically coupled to said control circuit, said power supply comprising:
a rechargeable battery being integrated into said pillow, said rechargeable battery being electrically coupled to said control circuit; and
a charge port being integrated into said outer wall of said pillow, said charge port being electrically coupled to said rechargeable battery.

5. The assembly according to claim 4, wherein:
each of said speakers is positioned within said respective prominence, each of said speakers being directed toward said first surface of said respective prominence such that said pair of speakers is directed toward each other, each of said speakers being electrically coupled to said control circuit; and
said assembly incudes a plurality of conductors, each of said conductors being positioned within said pillow, each of said conductors being electrically coupled between said control circuit and a respective one of said speakers.

6. The assembly according to claim 4, further comprising an audio cord having a first plug and a second plug, said first plug being insertable into said input port, said second plug being insertable into an output port of an audio source wherein said audio cord is configured to communicate the audio signal to said control circuit.

7. The assembly according to claim 4, further comprising a charge cord having a primary plug and a secondary plug, said primary plug being insertable into said charge port, said secondary plug being insertable into an output port of a charger for charging said rechargeable battery.

8. An audio emitting pillow assembly for facilitating a user to listen to music while having their head supported in an upright position, said assembly comprising:
a pillow being substantially hollow such that said pillow can be inflated, said pillow being curved wherein said pillow is configured to be positioned around a user's neck, said pillow having a pair of prominences extending upwardly from said pillow wherein each of said prominences is configured to be positioned adjacent to a respective one of the user's ears when said pillow is positioned around the user's neck, said pillow having a first end, a second end and an outer wall extending between said first end and said second end, each of said first end and said second end tapering to a blunt point, said outer wall being continuously arcuate about an axis extending between said first end and said second end such that said pillow has a cylindrical shape, said outer wall being curved between said first end and said second end having said first end being spaced from said second end such that said pillow has a U-shape, each of said prominences extending upwardly from said outer wall, each of said prominences being spaced an equal distance from a respective one of said first end and said second end of said pillow, each of said prominences having a first surface being directed toward each other;
an air valve being fluidly integrated into said outer wall of said pillow wherein said air valve is configured to pass air through said outer wall for inflating or deflating said pillow, said air valve having an inlet and a plug for closing said inlet;
a communication unit being integrated into said pillow, said communication unit being in remote communication with a personal electronic device wherein said communication unit is configured to receive streaming audio from the personal electronic device, said communication unit comprising:
a control circuit being integrated into said pillow;
a receiver being integrated into said pillow, said receiver being electrically coupled to said control circuit, said receiver being in wireless communication with the personal electronic device, said receiver receiving an audio signal from the personal electronic device;
an input port being integrated into said outer wall of said pillow, said input port being electrically coupled to said control circuit; and
a power supply being integrated into said pillow, said power supply being electrically coupled to said control circuit, said power supply comprising:
a rechargeable battery being integrated into said pillow, said rechargeable battery being electrically coupled to said control circuit; and
a charge port being integrated into said outer wall of said pillow, said charge port being electrically coupled to said rechargeable battery;
a pair of speakers, each of said speakers being integrated into a respective one of said prominences wherein each of said speakers is configured to be aligned with a respective one of the user's ears when said pillow is positioned around the user' neck, each of said speakers being in communication with said communication unit wherein each of said speakers is configured to audibly emit the streaming audio from the personal electronic device thereby facilitating the user to enjoy the streaming audio, each of said speakers being positioned within said respective prominence, each of said speakers being directed toward said first surface of said respective prominence such that said pair of speakers is directed toward each other, each of said speakers being electrically coupled to said control circuit;
a plurality of conductors, each of said conductors being positioned within said pillow, each of said conductors being electrically coupled between said control circuit and a respective one of said speakers;
an audio cord having a first plug and a second plug, said first plug being insertable into said input port, said second plug being insertable into an output port of an audio source wherein said audio cord is configured to communicate the audio signal to said control circuit;
a charge cord having a primary plug and a secondary plug, said primary plug being insertable into said charge port, said secondary plug being insertable into an output port of a charger for charging said rechargeable battery;
an air pump having a piston and an outlet, said outlet of said air pump being insertable into said inlet of said air valve in said outer wall of said pillow, said piston being movable back and forth for pumping air into said pillow thereby inflating said pillow; and
a storage bag having each of said pillow, said audio cord, said charge cord and said air pump being stored within said storage bag, said storage bag including a drawstring for closing said storage bag.
